(19) United States
(12) Patent Application Publication
(10) Pub. No.: US 2009/0136713 A1
(43) Pub. Date: May 28, 2009

(54) Optical layered product

(75) Inventors: Chikara Murata, Shizuoka-shi (JP); Kazuya Ooishi, Shizuoka-shi (JP); Masaomi Kuwabara, Shizuoka-shi (JP); Hideki Moriuchi, Shizuoka-shi (JP)

Correspondence Address: JORDAN AND HAMBURG LLP, 122 EAST 42ND STREET, SUITE 4000, NEW YORK, NY, 10168, US

(73) Assignee: Tomoegawa Co., Ltd., Tokyo (JP)

(21) Appl. No.: 12/291,632

(22) Filed: Nov. 12, 2008

Related U.S. Application Data
(63) Continuation-in-part of application No. 12/229,131, filed on Aug. 20, 2008.

(30) Foreign Application Priority Data
Aug. 22, 2007 (JP) 2007-216172

(51) Int. Cl. B32B 3/10

(52) U.S. Cl. 428/147

(57) ABSTRACT

An optical layered product has a translucent substrate onto which a radiation-curable resin layer containing translucent resin microparticles is layered. The layered product has an internal haze value (X) and a total haze value (Y) satisfying Y>X, Y≦X+7, X≦15 and X≧1, and has microirregularities on the outermost surface of the resin layer, to provide a functional film capable of satisfying antiglaring, contrast enhancement and antidazzling in a balanced manner in a configuration having a translucent substrate on which a single layer is layered.

### BACKGROUND OF THE INVENTION

1. Field of the Invention

The present invention relates to optical layered products to be provided on display surfaces of liquid crystal displays (LCDs), plasma displays (PDPs) and the like and, in particular, to optical layered products to be suitably used for large, high-definition liquid crystal television sets 30 inches or more in size, for example.

2. Background Art

Recently, displays such as LCDs and PDPs have been improved so that they can be produced and sold in various sizes for a number of applications ranging from cell phones to large-size television sets.

Such displays may have impaired visibility due to background reflections into the display surfaces of room lightings such as fluorescent lights, sunlight incident through windows and shadows of an operator. As such, in order to improve visibility, the display surfaces are provided with functional films over the outermost surface, such as antiglare films having microirregularities, which are capable of diffusing surface-reflected lights, suppressing specular reflections of external lighting and preventing background reflections of outside environments (having antiglare properties) (conventional AG).

These functional films are generally produced and sold as products comprising a translucent substrate such as polyethylene terephthalate (hereinafter referred to as “PET”) or triacetyl cellulose (hereinafter referred to “TAC”) over which a single antiglare layer having microirregularities is provided or as products comprising a light-diffusing layer onto which a low-refractive index layer is layered, with development now being carried out for functional films providing desired functions through combinations of layer configurations.

Recently, along with increases in size, increased definition and enhanced contrast of displays, however, there is now a need for enhancement of performance required for such functional films.

When an antiglare film is used for the outermost surface, images in black tend to be whiter due to diffusion of light with a disadvantageous decrease in contrast for use in a bright room. An antiglare film is therefore needed which attains a high contrast even at the sacrifice of antiglare properties (high-contrast AG).

In order to attain high contrast, a method has been adopted in which the top layer of an antiglare film is provided with one low-reflection layer or multiple layer alternately with high- and low-refractive index layers (AG with low-reflection layer).

On the other hand, when an antiglare film is used on the outermost surface, a problem arises in which dazzling (portions with high and low intensities in brightness) appears on the surface supposedly due to microirregularities, decreasing visibility. Such dazzling is likely to occur in association with increased definition in association with an increase in number of picture elements for a display and with improvement in display techniques such as picture element division schemes. An antiglare film having an antidazzle effect is therefore desired (high-definition AG).

In order to attain antidazzle effects, development is ongoing for a method as in Patent Reference 1, in which average peak spacing (Sm), center line average surface roughness (Ra) and average ten-point surface roughness (Rz) of the surface of functional films are specifically defined and for a method for regulating background reflection of external lighting into a display screen, dazzling phenomenon and white balance as in Patent References 2 and 3, in which areas of surface haze and internal haze are closely defined. As such, in designing light-diffusing sheets to be used for high-definition LCDs, internal diffusion properties for providing antidazzle effects and surface diffusion properties for providing antiwhitening effects are controlled.

Patent Reference 1: Japanese Unexamined Patent Publication No. 2002-196117

Patent Reference 2: Japanese Unexamined Patent Publication No. 1999-305010

Patent Reference 3: Japanese Unexamined Patent Publication No. 2002-267818

### SUMMARY OF THE INVENTION

### The Problem to be Solved

Thus, there are problems to be solved such as antiglare functions, contrast enhancement and antidazzling while there is a tradeoff in which one of the properties can be sought only at the sacrifice of the others. Background reflections of external lighting which were of little problem for small-size screens of mobile terminals and the like are now likely to arise as a problem for large-size screens. Thus, nothing so far has satisfied these functions with a configuration comprising a translucent substrate on which a single layer is layered. As such, as a method for providing these functions simultaneously, development is under way with respect to the surface topography of membranes and films to be layered in a multi-layer manner. Making to multi-layer, however, requires a process for coating a translucent substrate with multiple layers, incurring more cost. Also, it is difficult to adjust the balance among the multiple layers, only allowing in fact to select and implement part of these functions according to the intended use.

It is therefore a primary object of the present invention to provide an optical layered product applicable to high-definition LCDs, which has functions of antiglaring, contrast enhancement and antidazzling in a balanced manner and, in particular, to provide an optical layered product in which these functions are achieved in a configuration comprising a translucent substrate on which a single layer is layered.

### Means for Solving the Problem

As a result of keen studying, the present inventors have found that, through building a microstructure on the surface of an optical layered product and also varying internal and total haze values, a range exists within which all the functions of antiglaring, contrast enhancement and antidazzling, which have been considered in a tradeoff, are optimized, to successfully accomplish the present invention.

The present invention (1) is an optical layered product comprising a translucent substrate onto which a radiation-curable resin layer containing translucent resin microparticles is layered, which has an internal haze value (X) and a total haze value (Y) satisfying the formulae (1) to (4):

Y>X (1)

Y≦X+7 (2)

X≦15 (3) and

X≧1 (4),

and has microirregularities on the outermost surface of the resin layer. An internal haze value and a total haze value as defined in the present invention refer to a value with respect to a whole optical layered product. In other words, when an optical layered product has a function-imparting layer (for example, low-reflection layer) other than a translucent substrate and a radiation-curable resin layer, such a value refers to a value with respect to a whole optical layered product including such a function-imparting layer.

The present invention (2) is the optical layered product according to the invention (1) wherein the microirregularities have an average tilt angle of 0.4° to 1.6°.

The present invention (3) is the optical layered product according to the invention (1) or (2) wherein the microirregularities have an average peak spacing (Sm) of 50 to 250 μm.

The present invention (4) is the optical layered product according to any one of the inventions (1) to (3) wherein a low-reflection layer is provided over the resin layer.

### THE EFFECT OF THE INVENTION

The optical layered product according to the present invention has antiglare properties, high contrast and antidazzling in an excellently balanced manner despite the fact that it comprises a translucent substrate on which a single layer is layered, and enables highly visible, quality image displaying when it is used for a display surface. The optical layered product also enables a reduction in cost as it reduces the number of coating steps.

### DETAILED DESCRIPTION OF THE PREFERRED EMBODIMENTS

An optical layered product according to a preferred embodiment basically comprises a translucent substrate onto which a radiation-curable resin layer containing translucent resin microparticles is layered. Here, the resin layer may be layered onto one or both sides of the translucent substrate. Furthermore, the optical layered product may have other layers. Examples of such other layers may include a polarizing substrate, a low-reflection layer and another function-imparting layer, such as an antistatic layer, a near infrared radiation (NIR) absorption layer, a neon cut layer, an electromagnetic wave shield layer or a hard coat layer. For example, such layers may be located over that side of the translucent substrate opposite to the resin layer in the case of a polarizing substrate, over the resin layer in the case of a low-reflection layer, and under the resin layer in the case of another function-imparting layer. Each component of the optical layered product (translucent substrate, radiation-curable resin layer and so on) according to the preferred embodiment will be described in detail below.

To begin with, the translucent substrates according to the preferred embodiment are not particularly limited as long as they are translucent. Glasses such as quartz glass and soda glass may be used. However, various resin films of PET, TAC, polyethylene naphthalate (PEN), polymethyl methacrylate (PMMA), polycarbonate (PC), polyimide (PI), polyethylene (PE), polypropylene (PP), polyvinyl alcohol (PVA), polyvinyl chloride (PVC), cycloolefin copolymers (COC), norbornene-containing resins, polyether sulfone, cellophane, aromatic polyamides and the like may preferably be used. For use in PDPs and LCDs, films of PET and TAC are more preferable.

The transparency of such translucent substrates is preferably as high as possible. The total light transmittance (JIS K7105) of the substrates is preferably 80% or higher and more preferably 90% or higher. The thickness of the translucent substrates is preferably smaller in view of weight saving. In consideration of productivity and ease of handling, however, substrates having a thickness preferably in the range of 1 to 700 μm and more preferably in the range of 25 to 250 μm are preferably used.

Also, the adherence between the translucent substrate and the resin layer can be enhanced by subjecting the translucent substrate to surface treatment such as alkaline treatment, corona treatment, plasma treatment, sputtering and saponification and/or surface modification treatment such as application of surface active agents, silane coupling agents or the like or Si vapor deposition.

Next, the radiation-curable resin layer according to the preferred embodiment will be described in detail. The radiation-curable resin layers according to the preferred embodiment are not particularly limited as long as they are formed by radiation-curing a radiation-curable resin composition and, in addition, containing translucent resin microparticles. Examples of radiation-curable resin compositions for composing the resin layers include monomers, oligomers and prepolymers having radically polymerizable groups such as acryloyl, methacryloyl, acryloyloxy and methacryloyloxy groups or cationically polymerizable groups such as epoxy, vinyl ether and oxetane groups. Such radiation-curable resin compositions can be used alone or in combination as appropriate. Examples of monomers may include methyl acrylate, methyl methacrylate, methoxy polyethylene methacrylate, cyclohexyl methacrylate, phenoxyethyl methacrylate, ethylene glycol dimethacrylate, dipentaerythritol hexaacrylate, trimethylolpropane trimethacrylate and pentaerythritol triacrylate, and the like. Examples of oligomers and prepolymers may include acrylate compounds such as polyester acrylates, polyurethane acrylates, multifunctional urethane acrylates, epoxy acrylates, polyether acrylates, alkyd acrylates, melamine acrylates and silicone acrylates, unsaturated polyesters, epoxy-based compounds such as tetramethylene glycol diglycidyl ether, propylene glycol diglycidyl ether, neopentyl glycol diglycidyl ether, bisphenol-A diglycidyl ether and various cycloaliphatic epoxies as well as oxetane compounds such as 3-ethyl-3-hydroxymethyl oxetane, 1,4-bis-{[(3-ethyl-3-oxetanyl)methoxy]methyl}benzene and di[1-ethyl-(3-oxetanyl)]methyl ether. Such monomers, oligomers and prepolymers can be used alone or in combination.

The radiation-curable resin compositions described above can be cured as such by irradiation with electron beams. When they are cured by irradiation with ultraviolet radiations, however, addition of photopolymerization initiators will be needed. Radiations to be used may be ultraviolet radiations, visible lights, infrared radiations or electron beams. Also, these radiations may be polarized or non-polarized. Examples of photopolymerization initiators include radical polymerization initiators, such as acetophenones, benzophenones, thioxanthones, benzoin and benzoin methyl ether as well as cationic polymerization initiators, such as aromatic diazonium salts, aromatic sulfonium salts, aromatic iodonium salts and metallocene compounds. Such photopolymerization initiators can be used alone or in combination as appropriate.

According to the preferred embodiment, in addition to the radiation-curable resin compositions described above, polymeric resins may be added to such an extent that the polymerization curing may not be prevented. Such polymeric resins are thermoplastic resins soluble in organic solvents to be used for coating materials for resin layers to be subsequently referred to, examples of which include acrylic resins, alkyd resins and polyester resins. Such resins preferably contain acidic functional groups such as carboxyl, phosphoric and sulfonic groups.

Also, additives such as leveling agents, thickening agents and antistatic agents may be used. Leveling agents work to equalize the surface tension of coatings to repair any defects before formation of coatings. Substances lower in both interfacial tension and surface tension than the radiation-curable resin compositions described above are used as leveling agents. Thickening agents work to impart thixotropic properties to the radiation-curable resin compositions described above and are effective in formation of microirregularities on the surface of resin layers due to the prevention of translucent resin microparticles, pigments and the like from precipitation.

The resin layer mainly comprises a cured product of any of the radiation-curable resin compositions described above. A process for forming it comprises applying a coating material comprising a radiation-curable resin composition and an organic solvent and volatilizing the organic solvent, before irradiating with a radiation (for example, an electron beam or ultraviolet radiation) to effect curing. Organic solvents to be used here must be selected among those preferable for dissolving the radiation-curable resin compositions. Specifically, organic solvents selected from alcohols, esters, ketones, ethers and aromatic hydrocarbons may be used alone or in combination, in consideration of coatabilities such as wettability toward translucent substrates, viscosity and drying rate.

The thickness of the resin layer is in the range of 1.0 to 12.0 μm, more preferably in the range of 2.0 to 11.0 μm and even more preferably in the range of 3.0 to 10.0 μm. When the hard coat layer is smaller than 1 μm in thickness, because wear resistance of the resin layer deteriorates, a failure in curing may occur due to oxygen inhibition during ultraviolet radiation and when the hard coat layer is larger than 12 μm in thickness, shrinkage by curing the resin layer may cause curls, microcracks, a decrease in adhesion in relation to the translucent substrate or a decrease in translucency. It may also cause a cost increase due to an increase in coating material needed in association with the increase in film thickness.

As translucent resin microparticles to be contained in the radiation-curable resin layer, organic translucent resin microparticles composed of acrylic resins, polystyrene resins, styrene-acrylics copolymers, polyethylene resins, epoxy resins, silicone resins, polyvinylidene fluoride, polyethylene fluoride and the like may be used. The refractive index of the translucent resin microparticles is preferably from 1.40 to 1.75. When the refractive index is smaller than 1.40 or larger than 1.75, a difference in refractive index in relation to the translucent substrate or the resin matrix will be too great, lowering the total light transmittance. The difference in refractive index between the translucent resin microparticles and the resin is preferably 0.2 or less. The average particle size of the translucent resin microparticles is preferably in the range of 0.3 to 10 μm and more preferably in the range of 1 to 5 μm. The particle size smaller than 0.3 μm is not preferable, because antiglare properties will deteriorate, while the particle size larger than 10 μm is not preferable either, because dazzling will occur and the degree of surface irregularity will be so great that the surface may turn whitish. Also, proportions of the translucent resin microparticles to be contained in the resin described above are not particularly limited. It is, however, preferable that the proportions are from 1 to 20 parts by weight in relation to 100 parts by weight of the resin composition for satisfying properties such as antiglare and antidazzle functions and for easily controlling microirregularities of the surface of the resin layer and haze values. Here, “refractive index” refers to a value measured according to JIS K-7142. Also, “average particle size” refers to an average value of diameters of 100 particles as actually measured through an electron microscope.

According to the present invention, a polarizing substrate may be layered onto that side of the translucent substrate opposite to the radiation-curable resin layer. Here, as such a polarizing substrate, a light-absorbing polarizing film which transmits certain polarized lights and absorbs other lights or a light-reflecting polarizing film which transmits certain polarized lights and reflects other lights can be used. As light-absorbing polarizing films, films obtained by orientating polyvinyl alcohol, polyvinylene and the like can be used. For example, a polyvinyl alcohol (PVA) film obtained by uniaxially orientating polyvinyl alcohol to which iodine or a dyestuff is adsorbed as a dichroic element may be mentioned. Examples of light-reflecting polarizing films include DBEF of 3M, composed of several hundreds of alternate layers of two polyester resins (PEN and a PEN copolymer) exhibiting different refractive indices along the orientation direction upon orientation, which are laminated and orientated by an extrusion technique as well as NIPOCS of Nitto Denko Corporation and Transmax of Merck, Ltd. composed of a cholesteric liquid crystal polymer layer laminated with a ¼ waveplate, in which an incident light from the side of the cholesteric liquid crystal polymer is divided into two circularly polarized lights opposed to each other so that one of the lights may be transmitted and the other may be reflected, and the circularly polarized light transmitted through the cholesteric liquid crystal polymer layer is converted into a linearly polarized light through the ¼ waveplate.

Furthermore, a low-reflection layer may be provided over the radiation-curable resin layer in order to enhance contrast. In such a case, the refractive index of the low-reflection layer must be lower than that of the radiation-curable resin layer and is preferably 1.45 or less. Materials having such characteristics may include inorganic low-reflection materials comprising micronized inorganic materials such as LiF (refractive index n=1.4), MgF₂ (n=1.4), 3NaF.AlF₃ (n=1.4), AlF₃ (n=1.4) and Na₃AlF₆ (n=1.33) that are included in an acrylic resin, epoxy resin and the like as well as organic low-reflection materials such as fluorine-based or silicone-based organic compounds, thermoplastic resins, thermosetting resins and radiation-curable resins. Among them, fluorine-containing materials in particular are preferred for prevention of stains. Also, the low-reflection layer preferably has a critical surface tension of 20 dyne/cm or lower. When the critical surface tension is higher than 20 dyne/cm, stains adhered to the low-reflection layer will be difficult to remove.

Examples of fluorine-containing materials as described above may include vinylidene fluoride-based copolymers, fluoroolefin/hydrocarbon copolymers, fluorine-containing epoxy resins, fluorine-containing epoxy acrylates, fluorine-containing silicones and fluorine-containing alkoxysilanes, which are soluble in organic solvents and easy to handle. These materials can be used alone or in combination.

Also, fluorine-containing methacrylates, such as 2-(perfluorodecyl)ethyl methacrylate, 2-(perfluoro-7-methyloctyl)ethyl methacrylate, 3-(perfluoro-7-methyloctyl)-2-hydroxypropyl methacrylate, 2-(perfluoro-9-methyldecyl)ethyl methacrylate and 3-(perfluoro-8-methyldecyl)-2-hydroxypropyl methacrylate, fluorine-containing acrylates, such as 3-perfluorooctyl-2-hydroxypropyl acrylate, 2-(perfluorodecyl)ethyl acrylate and 2-(perfluoro-9-methydecyl)ethyl acrylate, epoxides, such as 3-perfluorodecyl-1,2-epoxypropane and 3-(perfluoro-9-methyldecyl)-1,2-epoxypropane as well as radiation-curable, fluorine-containing monomers, oligomers and prepolymers such as epoxy acrylates may be mentioned. These materials can be used alone or in combination.

Furthermore, a low-reflection material comprising a sol made of ultrafine silica particles with a size of 5 to 30 nm that are dispersed in water or an organic solvent in mixture with a fluorine-based film former may be used. Used as the sol made of ultrafine silica particles with a size of 5 to 30 nm that are dispersed in water or an organic solvent are known silica sols obtained by condensing an activated silicate, through a process for dealkalizing alkaline metal ions in an alkali silicate through ion exchange or the like or a process for neutralizing an alkali silicate with a mineral acid, known silica sols obtained by hydrolyzing and condensing an alkoxysilane in an organic solvent under the presence of a basic catalyst and known silica sols (organosilica sols) obtained by substituting water in the aqueous silica sols described above with an organic solvent by distillation and the like. These silica sols can be used both in aqueous and organic solvent types. For producing organic solvent-based silica sols, it is unnecessary to completely substitute water with an organic solvent. The silica sols described above contain 0.5 to 50% by weight of solid content as SiO₂. Configuration of the untrafine silica particles in the silica sols to be used may be varied, such as spherical, needle-shaped, plate-shaped and the like.

Also, as film formers, alkoxysilanes, metal alkoxides, hydrolysates of metal salts, fluorine-modified polysiloxanes and the like may be used. Among the film formers described above, fluorine-containing compounds may preferably be used in particular because they can suppress adhesion of oils due to a decrease in critical surface tension of the low-reflection layer. The low-reflection layer according to the present invention may be obtained by diluting the materials described above with a diluent for example and applying it over the radiation-curable resin layer by means of a spin coater, a roll coater, printing and the like, followed by drying and curing it by heat, radiation or the like (when an ultraviolet radiation is used, a photopolymerization initiator as described above is used). Although radiation-curable, fluorine-containing monomers, oligomers and prepolymers are excellent in antifouling properties, they are poor in wettability and thus cause problems that the low-reflection layer is repelled over the radiation-curable resin layer depending on composition and that the low-reflection layer is delaminated from the radiation-curable resin layer. It is, therefore, desirable to appropriately mix and use the monomers, oligomers and prepolymers having polymerizable unsaturated bonds, such as acryloyl series, methacryloyl series, acryloyloxy group and methacryloyloxy group, described as the radiation-curable resins mentioned above to be used for the radiation-curable resin layers.

When plastics-based films that are likely to be damaged by heat, such as PET and TAC, are used for the translucent substrates, radiation-curable resins are preferably selected as materials of these low-reflection layers.

Thicknesses for low-reflection layers to provide good antireflection functions can be calculated according to known equations. When incident light enters a low-reflection layer orthogonally, the following relationship must only be satisfied as conditions for the low-reflection layer not to reflect the light but to allow the light to be transmitted at 100%. In the equations, Nₒ represents the refractive index of the low-reflection layer, Nₛ represents the refractive index of the radiation-curable resin layer, h represents the thickness of the low-reflection layer and λₒ represents the wavelength of the light.

Nₒ=Nₛ^{1/2} (1)

Nₒh=λₒ/4 (2)

It will be appreciated that, according to the equation (1) above, in order to prevent the reflection of light at 100%, a material must only be selected such that the refractive index of the low-reflection layer may be the square root of the refractive index of the underlying layer (the radiation-curable resin layer). It is, however, difficult to find a material which fully satisfies this equation and therefore a material which is as close as possible to such a material is to be selected. According to the equation (2) above, the optimum thickness as an antireflection film for the low-reflection layer is calculated based on the refractive index of the low-reflection layer selected according to the equation (1) and on the wavelength of the light. For example, assuming the refractive indices of the radiation-curable resin layer and the low-reflection layer are 1.50 and 1.38 respectively and the wavelength of the light is 550 nm (reference of luminous efficacy), by substituting these values into the equation (2) above, the thickness of the low-reflection layer will be calculated as approximately 0.1 μm and preferably in the range of 0.1±0.01 μm.

Next, the optical layered product will be described in detail with respect its characteristics. The optical layered product preferably has an internal haze value (X) and a total haze value (Y) which satisfy the formulae (1) to (4) below. Here, “total haze value” refers to a haze value of an optical layered product and “internal haze value” refers to a value obtained by subtracting a haze value of a transparent sheet with pressure-sensitive adhesive from a haze value of an optical layered product over the microirregular surface of which the transparent sheet with pressure-sensitive adhesive is applied. Both the haze values refer to those measured according to JIS K7015.

Y>X (1)

Y≦+X+7 (2)

X≦15 (3)

X≧1 (4)

Within the range of Y>X+7, X≦15 and X≧1, the surface turns whitish, decreasing contrast, because light scattering effects on the surface increase. In particular, contrast in a bright room will be impaired. Within the range of Y>X, Y≦X+7 and X>15, contrast decreases, because light scattering effects within the optical layered product (especially, its optically functional layer) increase. In particular, contrast in a dark room will be impaired. Within the range of Y>X, X<1 and Y≦X+7, dazzling may appear, because light scattering effects within the optical layered product decrease. A preferred range is Y>X, Y≦X+7 and 10<x≦15.

Furthermore, the optical layered product has microirregularities on the outermost surface of the resin layer. Here, such microirregularities have an average tilt angle, calculated from an average tilt as given according to ASME 95, preferably in the range of 0.4° to 1.6°, more preferably in the range of 0.5° to 1.4° and even more preferably in the range of 0.6° to 1.2°. With an average tilt angle of less than 0.4°, antiglare properties will deteriorate, while with an average tilt angle of more than 1.6°, contrast will deteriorate, making the optical layered product unsuitable to be used for display surfaces. Further, such microirregularities have an average peak spacing (Sm) preferably in the range of 50 to 250 μm, more preferably in the range of 55 to 220 μm and even more preferably in the range of 60 to 180 μm.

Furthermore, the optical layered product has a transmitted image definition preferably in the range of 5.0 to 70.0 (a value measured according to JIS K7105, using a 0.5 mm optical comb) and more preferably in the range of 20.0 to 65.0. With a transmitted image definition below 5.0, contrast will deteriorate, while with a transmitted image definition above 70.0, antiglare properties will deteriorate, making the optical layered product unsuitable to be used for display surfaces.

Next, a process for producing optical layered products according to this preferred embodiment will be described in detail. First, a method for controlling various parameters as characteristics of the present invention, such as surface microirregularities and haze values, will be discussed in detail. First, in order to bring X (internal haze) within the range defined in the present invention, adjustment may be made by a difference in refractive index between the translucent microparticles and the radiation-curable resin and loading of the translucent microparticles (content per unit area). X within the range defined in the present invention may more easily be obtained by separating cases using the difference in refractive index.

Specifically, if the difference in refractive index is 0.02 or more and 0.07 or less, the amount of translucent microparticles contained in the total solid content of the radiation-curable resin layer may be 1.0% by weight or more and 7.0% by weight or less. Below 1.0% by weight, X will tend to be lower than that defined in the present invention, while at or above 7.0% by weight, X will tend to be higher than that defined in the present invention.

If the difference in refractive index is more than 0.07 and 0.10 or less, the amount of translucent microparticles contained in the total solid content of the radiation-curable resin layer may be 1.0% by weight or more and 4.0% by weight or less. Below 1.0% by weight, X will tend to be lower than that defined in the present invention, while above 4.0% by weight, X will tend to be higher than that defined in the present invention.

Also, bringing X (internal haze) and Y (total haze) within the ranges defined in the present invention may be enabled by adjusting loading of the translucent microparticles (content per unit area) and irregularities by the translucent microparticles through coating thickness, physical properties of coatings, drying conditions and the like. In particular, use of a thickening agent as a material can suppress sedimentation of filler and facilitate position adjustment of the filler along the thickness direction, enabling desired characteristics to be obtained. In order to obtain Y within the range defined in the present invention, the value of the particle size of the translucent microparticles (μm) divided by the film thickness of the radiation-curable resin layer (μm) must only be smaller than 1.0, in addition to having the relationship between the difference in refractive index and the translucent microparticles for obtaining X described above. Such a value is more preferably 0.95 or smaller and particularly preferably 0.92 or smaller. The lower limit of the value is not particularly limited and is 0.40, for example. When the upper limit of the value is 1.0 or larger, the translucent microparticles will tend to protrude from the surface of the radiation-curable resin layer to facilitate surface scattering at such protrusions, thereby giving Y higher than that defined in the present invention.

Here, as a method for bringing X and Y within the ranges defined in the present invention, a method may be adopted in which two kinds of translucent microparticles are used. The control described above may then be made more easily than when using a single kind of microparticles. In such a case, translucent microparticles whose refractive index is the same as that of the radiation-curable resin and translucent microparticles whose refractive index is different from that of the radiation-curable resin may be used in combination.

Although means for bringing X and Y within the ranges defined in the present invention have been described above, use of such means is not mandatory and specific means are not limited as long as X and Y within the ranges defined in the present invention may be obtained.

For other respects, procedures similar to those for conventional optical layered products are applicable. For example, processes for forming a resin layer over a translucent substrate are not particularly limited. For example, a translucent substrate is applied with a coating material containing a radiation-curable resin composition containing translucent microparticles and the coating material is dried, followed by curing to produce a resin layer having microirregularities on the surface. As a procedure for coating a translucent substrate with a coating material, any ordinary coating or printing method is applicable. Specifically, coating, such as air doctor coating, bar coating, blade coating, knife coating, reverse coating, transfer roll coating, gravure roll coating, kiss-roll coating, cast coating, spray coating, slot orifice coating, calendar coating, dam coating, dip coating and die coating as well as intaglio printing, such as gravure printing and stencil printing, such as screen printing may be used.

### EXAMPLES

Examples and Comparative Examples of the present invention will be illustrated below. “Parts” are intended to mean “parts by weight.”

A coating material for resin layer was obtained by dispersing a mixture comprising components for coating material shown in Table 1 for one hour in a sand mill and was applied by die head coating method onto one side of TAC as a transparent substrate having a film thickness of 80 μm and a total light transmittance of 92%. After drying at 100° C. for one minute, ultraviolet irradiation was carried out in nitrogen atmosphere using one 120 W/cm, beam-condensing, high-pressure mercury vapor lamp (irradiation distance 10 cm, irradiation time 30 seconds) to cure the coated film. Thus, optical layered products of Examples 1 and 2 and Comparative Examples 1 and 2 were obtained. Refractive indices for coating materials for resin layer shown in the table below are values from raw materials and refractive indices after curing are slightly varied in values (typically from 0.01 to 0.03).

| | components | manufacturers | trade names | RIs | pbw |
|---|---|---|---|---|---|
| Ex. | polyfunctional | Shin-Nakamura | A-TMM-3L | 1.49 | 61.0 |
| 1 | acrylate | Chemical Co., | | | |
| | | Ltd. | | | |
| | polyfunctional | Kyoeisha | UA-306H | 1.51 | 25.0 |
| | urethane-based | Chemical Co., | | | |
| | acrylate | Ltd. | | | |
| | crosslinked | Sekisui | SBX-6 | 1.59 | 1.0 |
| | polystyrene: | Plastics Co., | | | |
| | particle size | Ltd. | | | |
| | 6 μm | | | | |
| | spherical | Asahi Glass | NP-30 | 1.45 | 2.0 |
| | silica: | Co., Ltd. | | | |
| | particle size | | | | |
| | 3 μm | | | | |
| | photoinitiator | Ciba | Irgacure-184 | | 4.0 |
| | | Specialty | | | |
| | | Chemicals | | | |
| | | Inc. | | | |
| | leveling agent | BYK Japan KK | BYK-323 | | 0.5 |
| | CAP | Eastman | CAP482-20 | | 5.5 |
| | | Chemical | | | |
| | | Japan Ltd. | | | |
| | solvent | | MEK | | 90.0 |
| | solvent | | cyclohexanone | | 10.0 |
| Ex. | polyfunctional | Nippon | UV7600B | 1.50 | 86.0 |
| 2 | acrylate | Synthetic | | | |
| | | Chemical | | | |
| | | Industry Co., | | | |
| | | Ltd. | | | |
| | crosslinked | Soken | SX500 | 1.59 | 3.5 |
| | polystyrene: | Chemical & | | | |
| | particle size | Engineering | | | |
| | 5 μm | Co., Ltd. | | | |
| | photoinitiator | Ciba | Irgacure-907 | | 4.5 |
| | | Specialty | | | |
| | | Chemicals | | | |
| | | Inc. | | | |
| | leveling agent | BYK Japan KK | BYK-323 | | 0.5 |
| | CAP | Eastman | CAP482-20 | | 5.5 |
| | | Chemical | | | |
| | | Japan Ltd. | | | |
| | solvent | | MEK | | 90.0 |
| | solvent | | cyclohexanone | | 10.0 |
| Com. | polyfunctional | Nippon | UV7600B | 1.50 | 82.5 |
| Ex. | acrylate | Synthetic | | | |
| 1 | | Chemical | | | |
| | | Industry Co., | | | |
| | | Ltd. | | | |
| | porous silica: | Fuji Silycia | Sylosphere | 1.45 | 3.5 |
| | average | Chemical Ltd. | C-1504 | | |
| | particle size | | | | |
| | 4.5 μm | | | | |
| | urea-based | Ciba | Pergopak M-2 | 1.58 | 3.5 |
| | condensate: | Specialty | | | |
| | average | Chemicals | | | |
| | particle size | Inc. | | | |
| | 5.5 μm | | | | |
| | photoinitiator | Ciba | Irgacure-907 | | 4.5 |
| | | Specialty | | | |
| | | Chemicals | | | |
| | | Inc. | | | |
| | leveling agent | BYK Japan KK | BYK-323 | | 0.5 |
| | CAP | Eastman | CAP482-20 | | 5.5 |
| | | Chemical | | | |
| | | Japan Ltd. | | | |
| | solvent | | MEK | | 90.0 |
| | solvent | | cyclohexanone | | 10.0 |
| Com. | polyfunctional | DIC | 17-806 | 1.50 | 84.0 |
| Ex. | acrylate | | | | |
| 2 | | | | | |
| | porous silica: | Fuji Silycia | Sylosphere | 1.45 | 6.0 |
| | average | Chemical Ltd. | C-1504 | | |
| | particle size | | | | |
| | 4.5 μm | | | | |
| | photoinitiator | Ciba | Irgacure-907 | | 4.0 |
| | | Specialty | | | |
| | | Chemicals | | | |
| | | Inc. | | | |
| | leveling agent | BYK Japan KK | BYK-323 | | 0.5 |
| | CAP | Eastman | CAP482-20 | | 5.5 |
| | | Chemical | | | |
| | | Japan Ltd. | | | |
| | solvent | | MEK | | 90.0 |
| | solvent | | cyclohexanone | | 10.0 |

Using the optical layered products obtained in Examples 1 and 2 and Comparative Examples 1 and 2, haze values, total light transmittance, transmitted image definition, average tilt angle, Ra, Sm, antiglare properties, contrast and dazzling were measured and evaluated according to the procedure described below.

Haze values were measured according to JIS K7105, using a hazemeter (trade name: NDH 2000, Nippon Denshoku Industries Co., Ltd.).

Transparent sheets with pressure-sensitive adhesive used for measuring internal haze were as follows.

Transparent sheet

| | |
|---|---|
| Component: | polyethylene terephthalate (PET) |
| Thickness: | 38 μm |

Pressure-sensitive adhesive layer

| | |
|---|---|
| Component: | acrylic pressure-sensitive adhesive |
| Thickness: | 10 μm |
| Haze of transparent sheets with | 3.42 |
| pressure-sensitive adhesive | |

Total light transmittance was measured according to JIS K7105, using the hazemeter described above.

Transmitted image definition was measured according to JIS K7105, using an image clarity meter (trade name: ICM-1DP, Suga Test Instruments Co., Ltd.) set to the transmission mode with an optical comb width of 0.5 mm.

Average tilt angle was measured according to ASME 95, using a surface roughness measuring instrument (trade name: Surfcorder SE 1700α, Kosaka Laboratory Ltd.) by measuring average tilt and calculating the average tilt angle according to the equation:

Average tilt angle=tan⁻¹(average tilt)

Ra and Sm were measured according to JIS B0601-1994, using the surface roughness measuring instrument described above.

Antiglare properties were rated as , ◯ and × when the values of transmitted image definition were from 0 to 30, from 31 to 70 and from 71 to 100, respectively.

Contrast was measured as follows. A liquid crystal display (trade name: LC-37GX1W, Sharp Corporation) was laminated via a crystal-clear, pressure-sensitive adhesive layer over that side of the optical layered product of each of Examples and Comparative Examples opposite to the side where the resin layer was formed and the liquid crystal display was irradiated with a fluorescent lamp (trade name: HH4125GL, Matsushita Electric Industrial Co., Ltd.) from 60° upward to the front of the liquid crystal display screen so that the illuminance at the liquid crystal display surface could be 200 lux. Thereafter, values of brightness were measured when the liquid crystal display was rendered white in color and black in color with a photometer/colorimeter (trade name: BM-5A, Topcon Corporation). Contrast was then calculated by using the values of brightness (cd/m²) obtained when the display was rendered black in color and white in color according to the equation below and was rated as ×, ◯ and when the values were from 600 to 800, from 801 to 1,000 and from 1,001 to 1,200, respectively.

Contrast=brightness of display in white/brightness of display in black

Dazzling was measured as follows. A liquid crystal display with a resolution of 50 ppi (trade name: LC-32GD4, Sharp Corporation), a liquid crystal display with a resolution of 100 ppi (trade name: LL-T1620-B, Sharp Corporation), a liquid crystal display with a resolution of 120 ppi (trade name: LC-37GX1W, Sharp Corporation), a liquid crystal display with a resolution of 140 ppi (trade name: VGN-TX72B, Sony Corporation), a liquid crystal display with a resolution of 150 ppi (trade name: nw8240-PM780, Hewlett-Packard Japan, Ltd.) and a liquid crystal display with a resolution of 200 ppi (trade name: PC-CV50FW, Sharp Corporation) were laminated via a crystal-clear, pressure-sensitive adhesive layer over that side of the optical layered product of each of Examples and Comparative Examples opposite to the side where the resin layer was formed. The liquid crystal displays were rendered green in color in a dark room and then images were photographed by a CCD camera with a resolution of 200 ppi (CV-200C, Keyence Corporation) from a direction normal to each liquid crystal TV. Dazzling was measured when no variability in brightness was observed and rated as ×, ◯ and when the values of resolution were from 0 to 50 ppi, from 51 to 140 ppi and from 141 to 200 ppi, respectively.

The results of evaluations according to the evaluation procedures described above are shown in Table 1.

TABLE 1

| | Film | | | tot. | | | | | | | |
|---|---|---|---|---|---|---|---|---|---|---|---|
| | thickness | tot. | int. | light | Image | Ra | Sm | tilt | anti- | | |
| | (μm) | haze | haze | trans. | definition | (μm) | (μm) | angle | glare | contrast | dazzling |
| Ex. 1 | 7.0 | 12.5 | 7.5 | 93.0 | 40.5 | 0.16 | 150 | 0.90 | ∘ | | ∘ |
| Ex. 2 | 5.5 | 18.1 | 14.7 | 93.3 | 52.2 | 0.13 | 160 | 0.75 | ∘ | | |
| Com. 1 | 6.3 | 52.0 | 43.0 | 92.3 | 13.0 | 0.29 | 130 | 1.80 | | x | x |
| Com. 2 | 4.5 | 32.4 | 1.5 | 93.0 | 5.3 | 0.30 | 230 | 2.10 | | x | x |

The optical layered product of Example 1 satisfied antiglare properties, contrast and dazzling in a balanced manner, while the optical layered product of Comparative Example 1 where Y>X+7 failed to satisfy contrast and the optical layered product of Comparative Example 2 where X was smaller than 15 failed to satisfy dazzling.

### INDUSTRIAL APPLICABILITY

As described above, optical layered product films which satisfy antiglare properties, contrast and dazzling in a balanced manner may be provided by providing microirregularities on the outermost surface of a resin layer and by controlling internal and total haze values within appropriate ranges.

1. An optical layered product comprising a translucent substrate onto which a radiation-curable resin layer containing translucent resin microparticles is layered, which has an internal haze value (X) and a total haze value (Y) satisfying the formulae (1) to (4):
Y>X (1)
Y≦X+7 (2)
X≦15 (3) and
X≧1 (4),
and has microirregularities on an outermost surface of the resin layer.

2. The optical layered product according to claim 1, wherein the microirregularities have an average tilt angle of 0.4° to 1.6°.

3. The optical layered product according to claim 2, wherein the microirregularities have an average peak spacing (Sm) of 50 to 250 μm.

4. The optical layered product according to claim 3, wherein a low-reflection layer is provided over the resin layer.

5. The optical layered product according to claim 2, wherein a low-reflection layer is provided over the resin layer.

6. The optical layered product according to claim 1, wherein the microirregularities have an average peak spacing (Sm) of 50 to 250 μm.

7. The optical layered product according to claim 6, wherein a low-reflection layer is provided over the resin layer.

8. The optical layered product according to claim 1, wherein a low-reflection layer is provided over the resin layer.
